(19) United States
(12) Patent Application Publication
(10) Pub. No.: US 2009/0304999 A1
(43) Pub. Date: Dec. 10, 2009

(54) CORRUGATED PACKAGING AND INSULATION MATERIAL

(76) Inventor: Carlo Fascio, Woodbridge (CA)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/477,623

(22) Filed: Jun. 3, 2009

Related U.S. Application Data
(63) Continuation of application No. 10/508,243, filed on May 23, 2005, now abandoned.

(30) Foreign Application Priority Data
Mar. 19, 2002 (CA) 2377317
Aug. 20, 2002 (CA) 2398033

(51) Int. Cl. B32B 3/12; B32B 3/30; B29C 37/00

(52) U.S. Cl. 428/159; 428/167; 156/196

(57) ABSTRACT

The present invention relates to a corrugated product comprising a corrugated substrate, having a top surface and a bottom surface, laminated with a sheet material on its top and/or bottom surface. The substrate is selected from the group consisting of low-density polyethylene foam, high-density polyethylene film, low-density polyethylene film, polypropylene, Nylon 6,6, Nylon 6, paper, craft paper or Cotton Paper. The sheet material is selected from the group consisting of paper, polyethylene film, foil, low density polyethylene foam, high density polyethylene film, low density polyethylene film, polypropylene, Nylon 6,6, Nylon 6, paper, craft paper, Cotton Paper. The sheet material can have a pressure sensitive adhesive and backing paper applied to the side of the sheet not attached to the substrate. The present invention is suitable for providing cushioning and protection when wrapping furniture, molded into shapes to encapsulate a product being shipped, die cut and made into boxes or made into padded envelopes or pouches.

### CROSS REFERENCE TO RELATED APPLICATION

This application is a continuation of U.S. patent application Ser. No. 10/508,243, filed May 23, 2005, which a U.S. National Phase Patent Application of PCT/CA02/01876, filed Dec. 9, 2002, which are incorporated by reference as if fully set forth.

### BACKGROUND

This invention relates to a corrugated packaging and insulation material.

In particular the present invention provides a protective cushioning product formed by corrugating a substrate and method of making same.

### FIELD OF INVENTION

Conventional corrugated cardboard has been used as packing material.

Various combinations of corrugated cardboard with Styrofoam boards or bubble sheeting are known. However there is a need for a less expensive packaging material that is environmentally compatible.

### SUMMARY OF THE INVENTION

It is an object of the invention to provide a corrugated product for use as protective packaging or insulation barrier.

It is a further object of the invention to provide a method of making a corrugated product.

Thus in accordance with the present invention there is provided a corrugated product comprising a corrugated substrate, having a top surface and a bottom surface, laminated with a sheet material on one or both of its top and bottom surface. The substrate is selected from the group consisting of low-density polyethylene foam, high-density polyethylene film, low-density polyethylene film, polypropylene, Nylon 6,6, Nylon 6, paper, craft paper or Cotton Paper. The sheet material is selected from the group consisting of paper, polyethylene film, foil, low density polyethylene foam, high density polyethylene film, low density polyethylene film, polypropylene, Nylon 6,6, Nylon 6, paper, craft paper, Cotton Paper. The sheet material can have a pressure sensitive adhesive and backing paper applied to the side of the sheet not attached to the substrate.

In another embodiment of a corrugated product according to the present invention the corrugated substrate has a top surface and a bottom surface and a first sheet is laminated to the points between the corrugations of the top surface. The substrate is selected from the group consisting of low-density polyethylene foam, high-density polyethylene film, low-density polyethylene film, polypropylene, Nylon 6,6, Nylon 6, paper, craft paper or Cotton Paper. The first sheet is selected from the group consisting of paper, polyethylene film, foil, low density polyethylene foam, high density polyethylene film, low density polyethylene film, polypropylene, Nylon 6,6, Nylon 6, paper, craft paper, Cotton Paper. A second sheet is laminated to the points between the corrugations of the bottom surface. An expanded foamed material fills the spaces between the corrugations in the substrate and the first and/or second sheet material. The expanded foamed material typically comprises a resin and a chemical foaming agent. The resin is preferably selected from the group consisting of polyamides such as nylon, polystyrene, polypropylene, ethylene vinyl acetate (EVA), polyolefins, metalizine, low density polyethylene (LDPE), medium density polyethylene, high density polyethylene (HDPE), poly vinyl chloride (PVC), high impact polystyrene (HIPS), thermoplastic olefin (TPO), acrylonitrile butadiene styrene (ABS), polyethylene terephthalate (PET), polyurethane, polyacrylamide. The chemical foaming agent can be exothermic (nitrogen based) or endothermic (bicarbonate based). Examples of exothermic foaming agents are azo based compounds such as azodicarbonamide which on heating releases nitrogen gas. Examples of endothermic foaming agents include citric acid, citric acid and soda ash and sodium bicarbonate. A nucleating agent such as talc is often added to the chemical foaming agents on the market. The first and second sheets trap the expanded foam between the corrugated substrate and the sheets to provide additional cushioning and insulation properties to the product over simply the corrugations. The corrugated foam product of the present invention can be used as a protective cushioning packaging material, an insulation barrier, cushioned envelopes, void fill, sound barrier, carpet and flooring underlay or boxes for shipping and product packaging. It is recyclable and is water resistant.

In another embodiment the invention is directed to processes for making the corrugated products.

Further features of the invention will be described or will become apparent in the course of the following detailed description.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a perspective view of one embodiment of a corrugated product according to the present invention;

FIG. 2 is a schematic end plan view of the corrugated foam product of FIG. 1;

FIG. 3 is a schematic end plan view of another embodiment of a corrugated foam product according to the present invention;

FIG. 4 is a schematic end plan view of another embodiment of a corrugated foam product according to the present invention;

FIG. 5 is a schematic end plan view of another embodiment of a corrugated foam product according to the present invention;

FIG. 6 is a schematic end plan view of another embodiment of a corrugated foam product according to the present invention;

FIG. 7 is a schematic end plan view of another embodiment of a corrugated foam product according to the present invention;

FIG. 8 is a schematic end plan view of another embodiment of a corrugated foam product according to the present invention;

FIG. 9 is a schematic end plan view of another embodiment of a corrugated foam product according to the present invention;

FIG. 10 is a schematic end plan view of another embodiment of a corrugated product according to the present invention;

FIG. 11 is a schematic of an embodiment of a process according to the present invention to form the corrugated products of FIGS. 1 to 10;

FIG. 12 is a schematic end plan view of another embodiment of a corrugated product according to the present invention with the spaces between corrugation filled with an expanded foamed material;

FIG. 13 is a schematic end plan view of a sheet material for use in one process for the manufacture of the corrugated product of FIG. 12;

FIG. 14 is a schematic end plan view of an intermediate corrugated product, before expansion of the foamed material, prepared in one process for making the corrugated product of FIG. 12; and

FIG. 15 is a schematic of an embodiment of a process according to the present invention to form the corrugated products of FIG. 12.

### DETAILED DESCRIPTION OF THE PREFERRED EMBODIMENT

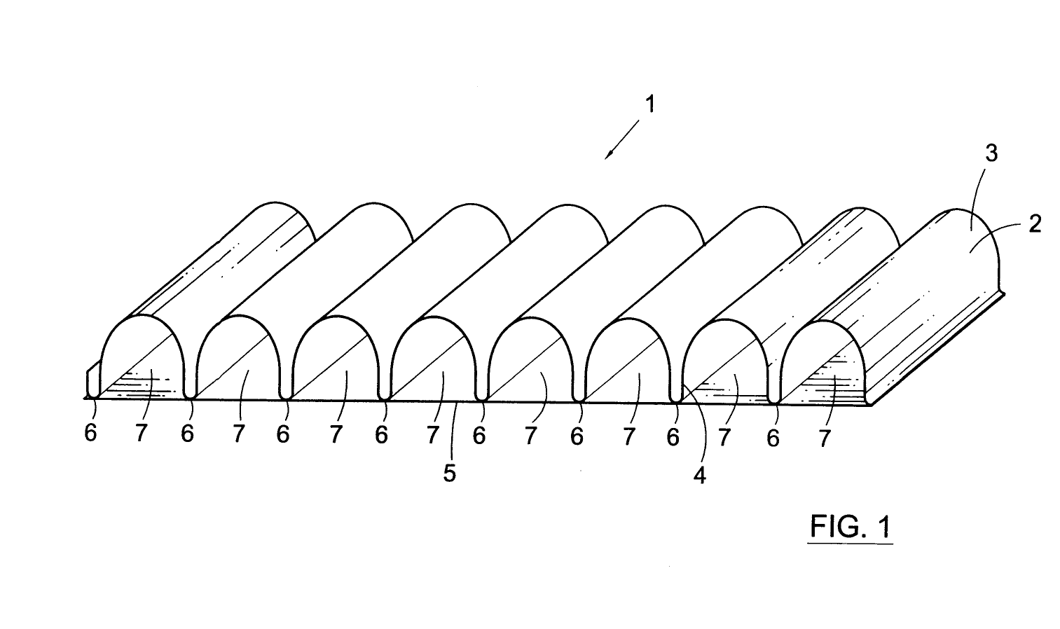

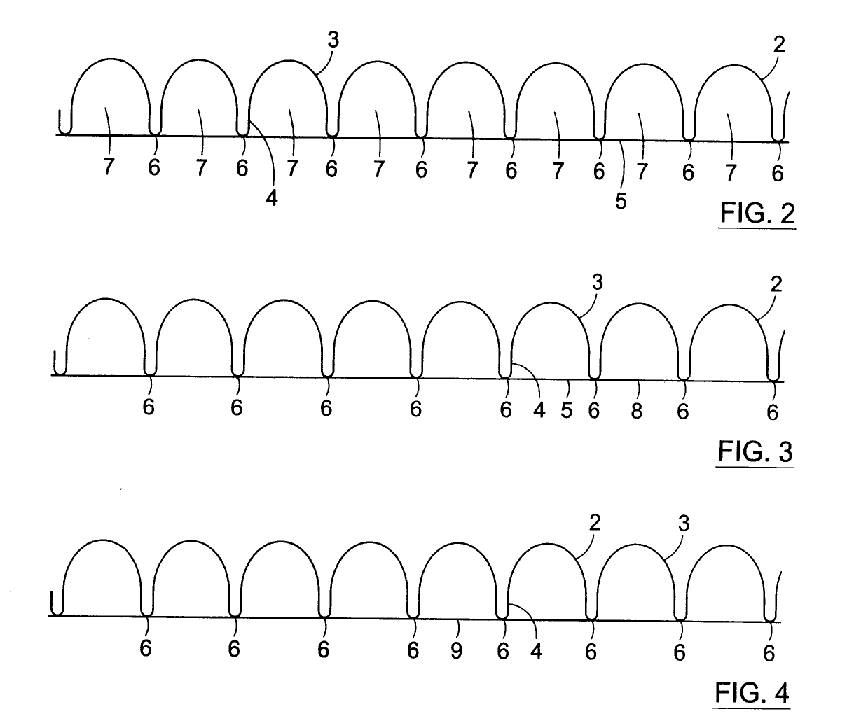

Referring to FIGS. 1 and 2, a corrugated product according to the present invention is generally indicated at 1. In the embodiment illustrated a corrugated substrate 2, having a top surface 3 and a bottom surface 4, is laminated with a sheet 5. In the embodiment illustrated the substrate 2 is selected from the group consisting of low-density polyethylene foam, high-density polyethylene film, low-density polyethylene film, polypropylene, Nylon 6,6, Nylon 6, paper, craft paper or Cotton Paper. The sheet 5 is selected from the group consisting of paper, polyethylene film, foil, low density polyethylene foam, high density polyethylene film, low density polyethylene film, polypropylene, Nylon 6,6, Nylon 6, paper, craft paper, Cotton Paper. The sheet material can have a pressure sensitive adhesive and backing paper applied to the side of the sheet not attached to the substrate. In FIGS. 1 and 2, the sheet 5 is laminated only on the points 6 between corrugations 7 of the bottom surface 4. In FIGS. 1 and 2 the corrugated foam substrate 2 is low-density polyethylene foam and the sheet 5 is paper. This provides a flexible product suitable for providing cushioning and protection when wrapping furniture, molded into shapes to encapsulate a product being shipped, die cut and made into boxes or to make padded envelopes or pouches.

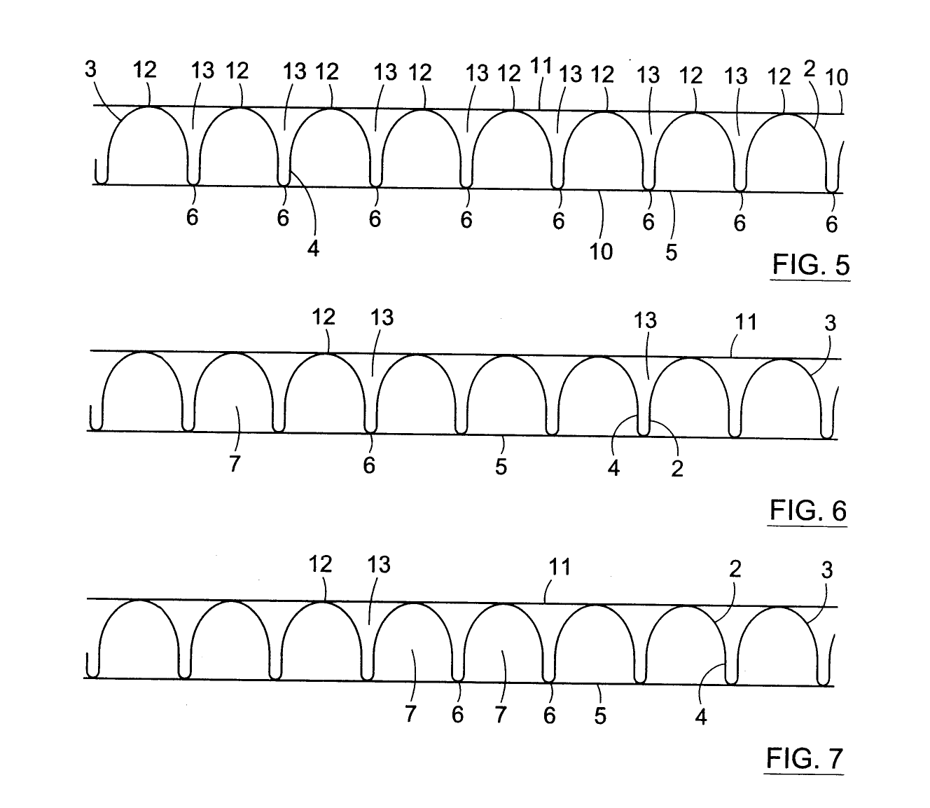

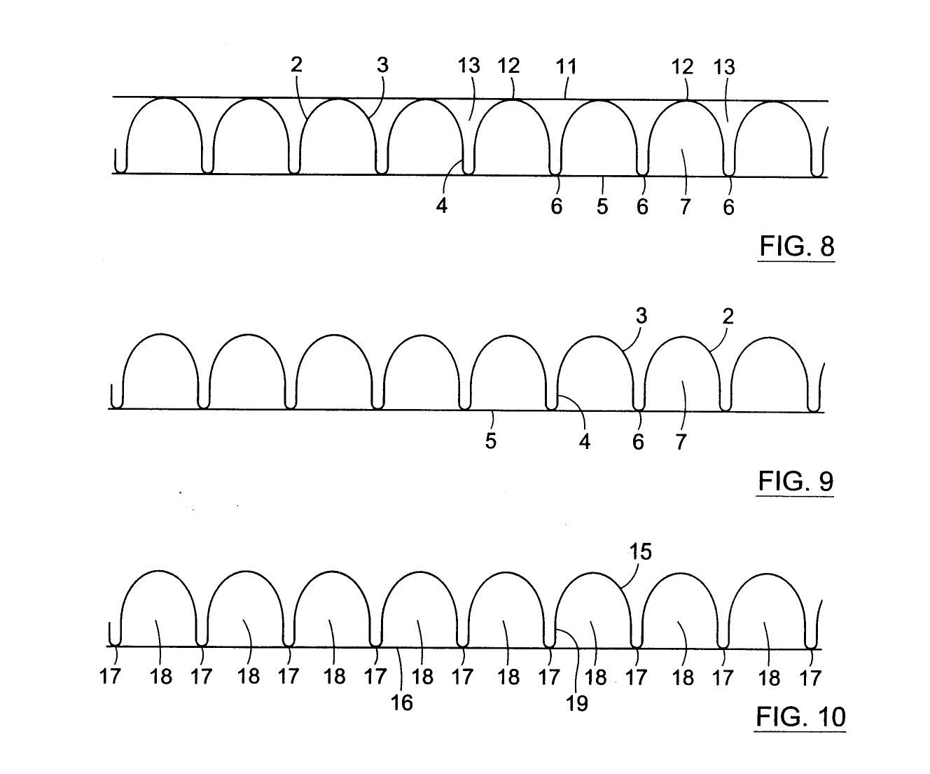

As noted above and shown in FIGS. 3 to 10, the sheet 5 can be selected from the group consisting of paper (as shown in FIGS. 1 and 2), low or high density polyethylene film 8 (see FIG. 3), polyethylene foam 9 (see FIG. 4) or aluminum foil covered with a tie layer 10 (see FIG. 5) depending on the properties required of the corrugated end product. A tie layer is preferably a layer of polyethylene or glue that is applied to the side of the sheet material that is adhered to the corrugated substrate. If the tie layer is polyethylene passing the sheet material over a heated roller, makes the polyethylene tacky so it will adhere to the corrugated substrate. If greater rigidity is required a second sheet 11, as shown in FIGS. 5 to 9 can be laminated to the points 12 between the corrugations 13 of the top surface 3. In FIG. 5 both the sheets 5 and 11 are an aluminum foil covered with a tie layer, preferably polyethylene. In FIG. 8 the sheet 5 is paper and the second sheet 11 is paper. In FIG. 6 both the sheet 5 and 11 are low or high-density polyethylene film. In FIG. 7 the sheets 5, 11 are both polyethylene foam. Selection of the appropriate sheet material will depend on the intended function of the corrugated end product. A foil sheet will act as a reflective insulation and vapour barrier. Paper acts as a moisture grabber and when laminated to the corrugated foam substrate it acts as a stiffener for the foam. This provides the foam with a memory so that it can be shaped into different cushioning products such as corner covers. A co-adhesive layer when laminated to the corrugated foam will allow the corrugated product to stick on all surfaces and be removed without leaving a residue. When a polyethylene film is laminated to the corrugated foam it becomes flexible and is an exceptional vapour barrier to retain or repel moisture.

In FIG. 9, the first sheet 5 is a paper and a co-adhesive layer is applied over the top surface 3 of the corrugated foam 2. The co-adhesive layer is basically a sheet material with an adhesive (glue) sprayed on to its surface. This sheet is then laminated to the corrugated layer. The purpose of the glue is that it will allow the corrugated product to be adhered to the product that it is protecting or wrapped around. The adhesive will allow the corrugated product to stick on all surfaces and be removed with out leaving a residue. The co-adhesive layer preferably includes a pressure sensitive adhesive and backing paper applied to the side of the sheet not attached to the substrate.

The sheets 5 and 11 trap air in the corrugations between the foam substrate and the sheets to provide cushioning and insulation properties to the product. The corrugated foam product of the present invention can be used as a protective cushioning packaging material, an insulation barrier, cushioned envelopes, void fill, sound barrier, carpet and flooring underlay or boxes for shipping and product packaging. It is recyclable and is water resistant. Where the product is used for thermal insulation, the sheets 5 and 11 are typically aluminum foil covered with a tie layer.

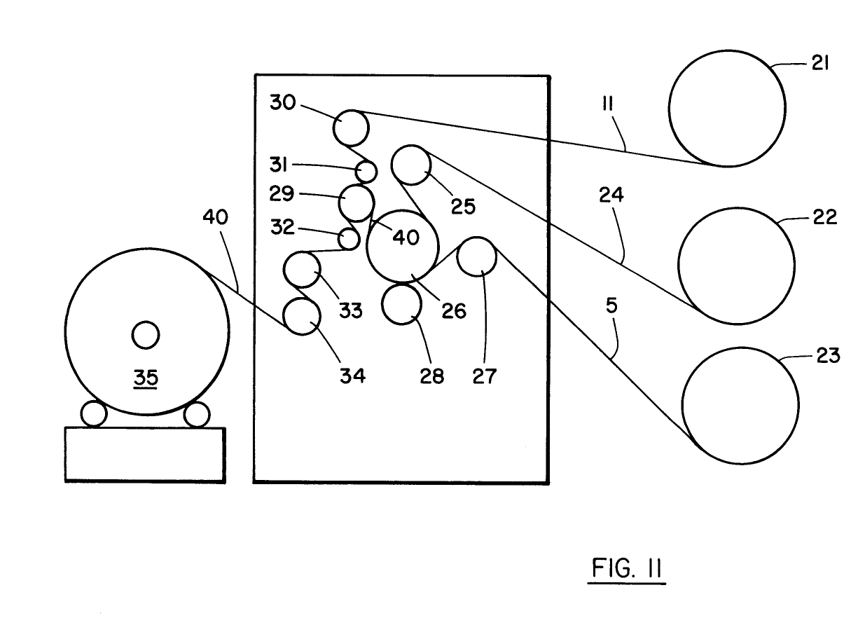

FIG. 10 shows a further embodiment of the present invention where a paper substrate 15 is corrugated and a polyethylene foam sheet 16 is laminated to the points 17 between corrugations 18 on the bottom surface 19 of the corrugated paper substrate 15.

FIG. 11 illustrates schematically one method of making the corrugated foam products of the present invention. In FIG. 11 three rolls 21,22, 23 are shown. The roll 22 contains the foam substrate 24 that will be corrugated to form the corrugated foam substrate 2. Roll 23 contains the sheet 5 and roll 24 contains sheet 11. The foam substrate 24 from roll 22 is threaded over a heated idler roller 25 that is capable of releasing steam into the substrate when it is a paper substrate being corrugated. This heated idler roller 25 is preferably oil heated. The foam substrate 24 is then together with sheet material 5 from roll 23 fed between a corrugation mould 26 and heated nip roller 28 that is capable of releasing steam into sheet 5 when it is a paper substrate. Before being fed between a corrugation mould 26 and heated nip roller 28, sheet 5 is fed over idle roller 27. The heated foam substrate 24 is tacky and as it is fed between the corrugation mould 26 and heated nip roller 28, sheet 5 is laminated to the foam substrate. The corrugated substrate 24 together with sheet 5 forming web 40 are then fed over heated idler roller 29. At this point sheet 11 from roll 21, if any, has passed over heated idle roller 30. Sheet 11 is then fed together with web 40 between secondary heated nip roll 31 and heated idle roller 29 where the sheet 11 is laminated to the top surface of the foam substrate 24. The web 40 then is fed around chilled rollers 32,33 and 34 and onto the winder 35.

The process described above is the same for the various combinations and substrates to be corrugated and sheet materials with the appropriate material on rolls 21, 22 and 23.

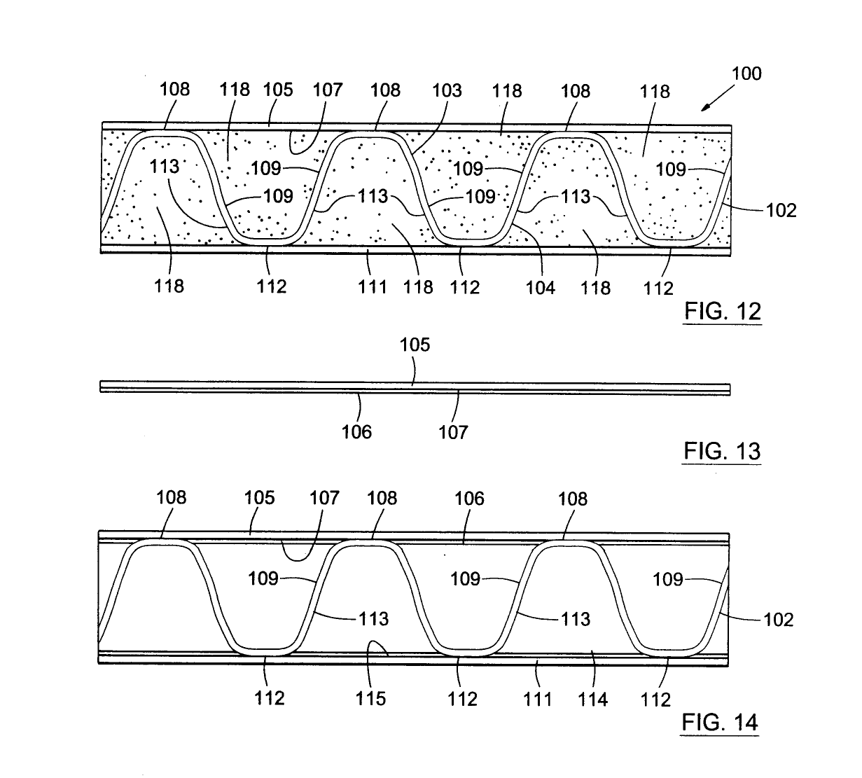

Referring to FIG. 12, another embodiment of a corrugated product according to the present invention is generally indicated at 100. In the embodiment illustrated a corrugated substrate 102, having a top surface 103 and a bottom surface 104, is laminated with a first sheet 105. In the embodiment illustrated the substrate 102 is selected from the group consisting of low-density polyethylene foam, high-density polyethylene film, low-density polyethylene film, polypropylene, Nylon 6,6, Nylon 6, paper, craft paper or Cotton Paper. The sheet 105 is preferably selected from the group consisting of paper, polyethylene film, foil, low density polyethylene foam, high density polyethylene film, low density polyethylene film, polypropylene, Nylon 6,6, Nylon 6, paper, craft paper, Cotton Paper. FIG. 13 illustrates the construction of one embodiment of a sheet material 105, for use in one process of making the corrugated product 100, prior to being laminated to the corrugated substrate 102. In the embodiment illustrated, the sheet material 105 has a thin layer of film 106 applied to the side 107 of the sheet 105 to be attached to the substrate 102. This thin film layer 106 preferably comprises an expandable resin and a chemical foaming agent. The resin is preferably elected from the group consisting of polyamides such as nylon, polystyrene, polypropylene, ethylene vinyl acetate (EVA), polyolefins, metalizine, low density polyethylene (LDPE), medium density polyethylene, high density polyethylene (HDPE), poly vinyl chloride (PVC), high impact polystyrene (HIPS), thermoplastic olefin (TPO), acrylonitrile butadiene styrene (ABS), polyethylene terephthalate (PET), polyurethane, polyacrylamide. The chemical foaming agent can be exothermic (nitrogen based) or endothermic (bicarbonate based). Examples of exothermic foaming agents are azo based compounds such as azodicarbonamide which on heating releases nitrogen gas. Examples of endothermic foaming agents include citric acid, citric acid and soda ash and sodium bicarbonate. A nucleating agent such as talc is often added to the chemical foaming agents on the market. Sheet 105 is laminated only on the points 108 between corrugations 109 of the top surface 103 of substrate 102. In FIG. 12, the thin layer of film 106 has been heated to expand and the expanded foam material 118 fills in all the voids between the corrugation flutes 109 and the side 107 of sheet 105. In FIG. 12 the corrugated substrate 102 is paper and the sheet 105 is paper. A second sheet 111 is laminated to the points 112 between the corrugations 113 of the bottom surface 104. The second sheet material 111 has a thin layer of film 114 (see FIG. 14) applied to the side 115 of the sheet 111 to be attached to the substrate 102. FIG. 14 shows the sheet material 105 and 111 laminated to the substrate 102 before heating and expansion of the film layers 106 and 114. Sheet 111 is laminated only on the points 112 between corrugations 113 of the bottom surface 104. In FIG. 12, the film 114 has been heated to expand and the expanded foam material 118 fills in all the voids between the corrugation flutes 113 and the side 115 of sheet 111. The sheets 105 and 111 trap the expanded foam 118 in the corrugations 109,113 between the corrugated substrate 102 and the sheets 105, 111 to provide cushioning and insulation properties to the product. The corrugated foam product of the present invention can be used as a protective cushioning packaging material, an insulation barrier, cushioned envelopes, void fill, sound barrier, carpet and flooring underlay or boxes for shipping and product packaging. It is recyclable and is water resistant.

There are emerging methods of expanding a resin material to create an expanded foam material without gas by using for example microvoids instead of chemical foaming agents. When film compounded with sub-micron sized clay fillers is oriented, the plastic pulls away from the filler particles, opening micro-voids. All such methods of expanding the resin material are included in the scope of the present invention.

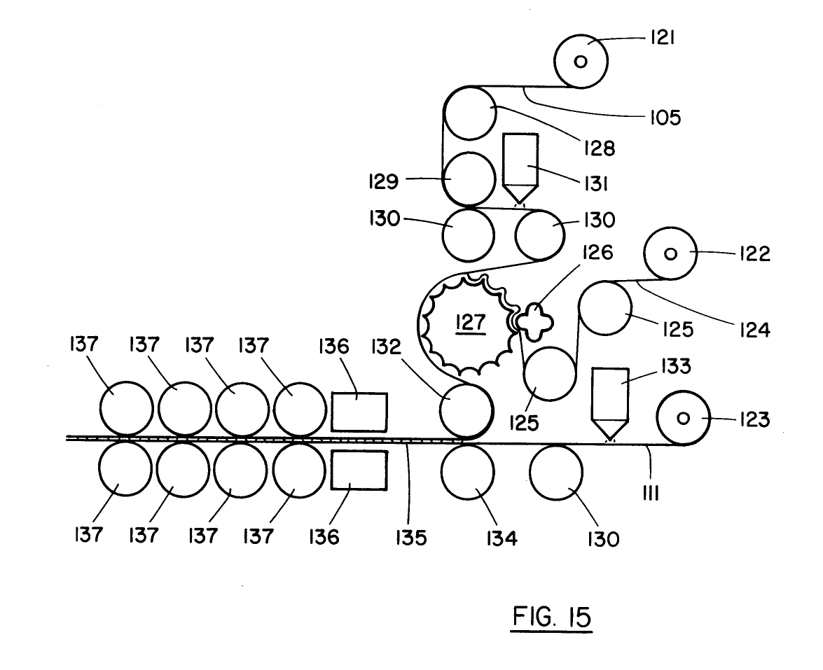

FIG. 15 illustrates schematically one method of making the corrugated foam products of FIG. 12. In FIG. 15 three rolls 121,122, 123 are shown. The roll 122 contains the substrate 124 that will be corrugated to form the corrugated substrate 102. Roll 121 contains the sheet 105 and roll 123 contains sheet 111. The substrate 124 from roll 122 is threaded over a heated idler roller 125 that is capable of releasing steam into the substrate when it is a paper substrate being corrugated. This heated idler roller 125 is preferably oil heated. The substrate 124 is then fed through a pair of male 126 and female 127 rotary dies to create the center flute 109,113 of the corrugated structure.

While substrate 102 is being corrugated, the sheets 105, 111 are drawn off rolls 121, 123. Sheet 105 bases over idle roller 128 and between idle rollers 129, 130. Sheet 105 then passes under the extruder die 131 where a thin layer of film 106 is laminated to the surface of sheets 105. This thin film layer 106 comprises an expandable resin and a chemical foaming agent. The resin is selected from the group consisting of polyamides such as nylon, polystyrene, polypropylene, ethylene vinyl acetate (EVA), polyolefins, metalizine, low density polyethylene (LDPE), medium density polyethylene, high density polyethylene (HDPE), poly vinyl chloride (PVC), high impact polystyrene (HIPS), thermoplastic olefin (TPO), acrylonitrile butadiene styrene (ABS), polyethylene terephthalate (PET), polyurethane, polyacrylamide. The resin is preferably LDPE. The chemical foaming agent can be exothermic (nitrogen based) or endothermic (bicarbonate based). Examples of exothermic foaming agents are azo based compounds such as azodicarbonamide which on heating releases nitrogen gas. Examples of endothermic foaming agents include citric acid, citric acid and soda ash and sodium bicarbonate. A nucleating agent such as talc are often added to the chemical foaming agents on the market.

As substrate 102 is corrugated to form the flutes 109, 113, the sheet 105 is fed between nip roller 130 and corrugated substrate 102 as it passes over female die 127. As the two webs formed by substrate 102 and sheet 105 continue around the mold (female rotary die) 127. Sheet 105 is laminated only on the points 108 between corrugations 109 of the top surface 103. Thin film layer 106 is still sticky after being applied to sheet 105. This enables the sheet material 105 to stick to the points 108 on substrate 102. As the film layer 106 is tacky and it is run through nip roller 130 the film layer 106 becomes thinner at the points 108 that it contacts the substrate 102 and will then not expand and distort the corrugations or flute 109 when subsequently heated. As the lamination of substrate 102 and sheet 105 passes under rotary die 127, it starts to wrap around nip roller 132 where the second sheet material 111 is introduced and adhered to the bottom of the surface 104 of substrate 102.

The sheet material 111 is drawn from roll 123 under the extruder die 133 where a thin layer of film 114 is applied to the side 115 of the sheet 111 to be attached to the substrate 102. This thin film layer 106 comprises an expandable resin and a chemical foaming agent. The resin is selected from the group consisting of polyamides such as nylon, polystyrene, polypropylene, ethylene vinyl acetate (EVA), polyolefins, metalizine, low density polyethylene (LDPE), medium density polyethylene, high density polyethylene (HDPE), poly vinyl chloride (PVC), high impact polystyrene (HIPS), thermoplastic olefin (TPO), acrylonitrile butadiene styrene (ABS) polyethylene terephthalate (PET), polyurethane, polyacrylamide. The resin is preferably LDPE. The chemical foaming agent can be exothermic (nitrogen based) or endothermic (bicarbonate based). Examples of exothermic foaming agents are azo based compounds such as azodicarbonamide which on heating releases nitrogen gas. Examples of endothermic foaming agents include citric acid, citric acid and soda ash and sodium bicarbonate. A nucleating agent such as talc are often added to the chemical foaming agents on the market. Sheet 111 passes with the lamination of substrate 102 and sheet 105 through the nip rollers 132 and 134 and is laminated only on the points 112 between corrugations 113 of the bottom surface 104 of substrate 102. Thin film layer 114 is still sticky after being applied to sheet 111. This enables the sheet material 111 to stick to the points 112 on substrate 102. As the film layer 114 is tacky and it is run through nip roller 132, 134 the film layer 114 becomes thinner at the points 112 that it contacts the substrate 102 and will then not expand and distort the corrugations or flute 113 when subsequently heated.

The laminated structure 135 now proceeds through a heat source, in the embodiment shown a RF (radio frequency) machine 136, that heats the film layers 106,114 causing them to expand (foam) and fill in all the voids between the corrugation flutes 109, 113 and the sides 107, 115 of sheets 105, 111 respectively. As the expanded foam 118 is expanding the laminated structure 135 travels through cooled gauging nip rollers 137 that control the expansion of foam 118. Properties of the foam can be modified by cross linking and orientation steps. Such additional steps are included in the scope of the present invention where applications require.

Having illustrated and described a preferred embodiment of the invention and certain possible modifications thereto, it should be apparent to those of ordinary skill in the art that the invention permits of further modification in arrangement and detail. All such modifications are covered by the scope of the invention.

What is claimed is:

1. A corrugated product comprising a corrugated substrate, having a top surface and a bottom surface, laminated with a first sheet material on the bottom surface of said corrugated substrate wherein said corrugated substrate selected from the group consisting of low-density polyethylene foam, high density polyethylene film, low density polyethylene film, polypropylene, Nylon 6,6, Nylon 6, paper, craft paper or Cotton Paper and said first sheet material selected from the group consisting of paper, polyethylene film, foil, low density polyethylene foam, high density polyethylene film, low density polyethylene film, polypropylene, Nylon 6, 6, Nylon 6, paper, craft paper and Cotton Paper, wherein said first sheet is laminated with a thin layer of an exothermic or endothermic LDPE film and heated to cause the thin layer of an exothermic or endothermic LDPE film to expand and fill the voids between corrugations.

2. A corrugated product according to claim 1 laminated with a second sheet material on the top surface of said corrugated substrate, said second sheet material selected from the group consisting of paper, polyethylene film, foil, low density polyethylene foam, high density polyethylene film, low density polyethylene film, polypropylene, Nylon 6, 6, Nylon 6, paper, craft paper and Cotton Paper.

3. A corrugated product according to claim 2 wherein one or both of said first or second sheet material has a pressure sensitive adhesive and backing paper applied to the side of said first or second sheet not attached to the corrugated substrate.

4. A corrugated product according to claim 2 wherein the said first or second sheet material is covered with a tie layer, said tie layer being polyethylene or an adhesive.

5. A corrugated product according to claim 1 wherein the corrugated substrate is low-density polyethylene foam.

6. A corrugated product according to claim 5 wherein the first sheet material is paper.

7. A corrugated product according to claim 5 wherein the first sheet material is low-density polyethylene film or high-density polyethylene film.

8. A corrugated product according to claim 5 wherein the first sheet material is polyethylene foam.

9. A corrugated product according to claim 6 wherein a second sheet material is laminated to the top surface of said corrugated substrate and said second sheet material is paper.

10. A process for making a corrugated product comprising a corrugated substrate, having a top surface and a bottom surface, laminated with a first sheet material on the bottom surface of said corrugated substrate wherein said corrugated substrate selected from the group consisting of low-density polyethylene foam, high density polyethylene film, low density polyethylene film, polypropylene, Nylon 6,6, Nylon 6, paper, craft paper or Cotton Paper and said first sheet material selected from the group consisting of paper, polyethylene film, foil, low density polyethylene foam, high density polyethylene film, low density polyethylene film, polypropylene, Nylon 6,6, Nylon 6, paper, craft paper and Cotton Paper, wherein said first sheet is laminated with a thin layer of an exothermic or endothermic LDPE film, the process comprising the following steps:
a. heating a substrate to be corrugated, then feeding the heated substrate together with a sheet material between a corrugation mould and nip roll to corrugate the substrate and laminate the sheet material to the bottom surface of the substrate to form a web with air trapped in the corrugations of the substrate, whereby the heating causes the thin layer of the LDPE film to expand and fill the voids between corrugations; then
b. cooling the web.

11. A process according to claim 10 comprising the additional step of laminating a second sheet material on the top surface of said corrugated substrate, said second sheet material selected from the group consisting of paper, polyethylene film, foil, low density polyethylene foam, high density polyethylene film, low density polyethylene film, polypropylene, Nylon 6,6, Nylon 6, paper, craft paper and Cotton Paper.

12. A process according to claim 11 wherein one or both of said first or second sheet material has a pressure sensitive adhesive and backing paper applied to the side of said first or second sheet not attached to the corrugated substrate

13. A process according to claim 11 wherein the said first or second sheet material is covered with a tie layer, said tie layer being polyethylene or an adhesive.

14. A process according to claim 10 wherein the corrugated substrate is low-density polyethylene foam.

15. A process according to claim 14 wherein the first sheet material is paper.

16. A process according to claim 14 wherein the first sheet material is low- density polyethylene film or high-density polyethylene film.

17. A process according to claim 14 wherein the first sheet material is polyethylene foam.

18. A corrugated product comprising a corrugated substrate selected from the group consisting of low-density polyethylene foam, high density polyethylene film, low density polyethylene film, polypropylene, Nylon 6,6, Nylon 6, paper, craft paper or Cotton Paper and including a top surface and a bottom surface, laminated with a first sheet material selected from the group consisting of paper, polyethylene film, foil, low density polyethylene foam, high density polyethylene film, low density polyethylene film, polypropylene, Nylon 6, 6, Nylon 6, paper, craft paper and Cotton Paper, wherein the corrugated substrate is laminated with the first sheet material on the bottom surface of said corrugated substrate and said first sheet is laminated with a thin layer of an exothermic or endothermic LDPE film and heated to cause the thin layer of an exothermic or endothermic LDPE film to expand and fill the voids between corrugations.

19. A corrugated product according to claim 18 laminated with a second sheet material on the top surface of said corrugated substrate, said second sheet material selected from the group consisting of paper, polyethylene film, foil, low density polyethylene foam, high density polyethylene film, low density polyethylene film, polypropylene, Nylon 6, 6, Nylon 6, paper, craft paper and Cotton Paper.

20. A corrugated product according to claim 19 wherein one or both of said first or second sheet material has a pressure sensitive adhesive and backing paper applied to the side of said first or second sheet not attached to the corrugated substrate.
